(19) United States
(12) Patent Application Publication
(10) Pub. No.: US 2022/0277327 A1
(43) Pub. Date: Sep. 1, 2022

(54) COMPUTER-BASED SYSTEMS FOR DATA DISTRIBUTION ALLOCATION UTILIZING MACHINE LEARNING MODELS AND METHODS OF USE THEREOF

(71) Applicant: Capital One Services, LLC, McLean, VA (US)

(72) Inventors: Peter Deng, Flushing, NY (US); Jihan Wei, Jersey City, NJ (US)

(21) Appl. No.: 17/186,207

(22) Filed: Feb. 26, 2021

(51) Int. Cl. G06Q 30/02; G06F 16/2458; G06N 5/04; G06Q 10/04; G06F 17/18

(52) U.S. Cl. CPC G06Q 30/0204; G06F 16/2474; G06N 5/046; G06Q 10/04; G06F 17/18; G06Q 40/025

(57) ABSTRACT

Systems and methods of the present disclosure enable distribution modelling and forecasting for populations and sub-populations of entities by employing a processor to receive a numerical data history for a population of entities, with the numerical data history including a series of activity-related quantity indices through time and the population of entities including sub-populations. The processor determines a combination of normal distributions approximating an index distribution for the sub-population of the entities based on the series of activity-related quantity indices, where the normal distributions are centered around a respective mean quantity value of a respective sub-population. The processor uses the normal distributions to eliminate simulations by using a Bayesian model to approximate an inferred index distribution for a particular sub-population. The processor determines at least one inferred statistical value based on the inferred index distribution.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC, All Rights Reserved.

### FIELD OF TECHNOLOGY

The present disclosure generally relates to computer-based systems configured for improved modelling of distributions of electronic indices in data scarce applications including prediction of future metrics based on the modelled distributions.

### BACKGROUND OF TECHNOLOGY

Various scenarios can benefit from robust statistical analysis of numerical data to model future distributions. However, existing solutions for such analysis are inefficient, requiring high data storage requirements and high processor requirements. Moreover, in addition to the inefficiencies, such attempts are unstable, particularly where data is scarce. Further attempts to overcome challenges of data scarcity compound the inefficiencies.

### SUMMARY OF DESCRIBED SUBJECT MATTER

In some embodiments, the present disclosure provides an exemplary technically improved computer-based method that includes at least the following steps of receiving, by at least one processor from an entity database, a numerical data history for a population of entities, where the numerical data history includes a series of activity-related quantity indices through time, where the population of entities includes a plurality of sub-populations of the entities; generating, by the at least one processor, a hierarchical map object representing a hierarchical scheme of sub-populations of the entities within the population of the entities; identifying, by the at least one processor, at least one sub-population of the plurality of sub-populations within which a selected sub-population is included based on the hierarchical map object; determining, by the at least one processor, a combination of a plurality of normal distributions approximating an index distribution for the at least one sub-population of the entities based on the series of activity-related quantity indices through time, where at least one normal distribution of the plurality of normal distributions is a respective sub-distribution of the index distribution centered around a respective mean quantity value of a respective sub-population; eliminating, by the at least one processor, simulations by using a Bayesian model to approximate an inferred index distribution for a particular sub-population within the population based on the combination of the plurality of normal distributions; determining, by the at least one processor, at least one inferred statistical value based on the inferred index distribution; and filtering, by the at least one processor, the population of entities within the entity database based on the at least one inferred statistical value and a predetermined statistical value threshold.

In some embodiments, the present disclosure provides an exemplary technically improved computer-based system that includes at least the following components of at least one processor configured to execute software instructions. The software instructions cause the at least one processor to perform steps to: receive, from an entity database, a numerical data history for a population of entities, where the numerical data history includes a series of activity-related quantity indices through time, where the population of entities includes a plurality of sub-populations of the entities; generate a hierarchical map object representing a hierarchical scheme of sub-populations of the entities within the population of the entities; identify at least one sub-population of the plurality of sub-populations within which a selected sub-population is included based on the hierarchical map object; determine a combination of a plurality of normal distributions approximating an index distribution for the at least one sub-population of the entities based on the series of activity-related quantity indices through time, where at least one normal distribution of the plurality of normal distributions is a respective sub-distribution of the index distribution centered around a respective mean quantity value of a respective sub-population; eliminate simulations by using a Bayesian model to approximate an inferred index distribution for a particular sub-population within the population based on the combination of the plurality of normal distributions; determine at least one inferred statistical value based on the inferred index distribution; and filter the population of entities within the entity database based on the at least one inferred statistical value and a predetermined statistical value threshold.

The systems and methods of the present disclosure further include determining, by the at least one processor, a quality score associated with the particular sub-population based on the inferred statistical value relative to at least one other inferred statistical value; and causing to display, by the at least one processor, a quality score user interface on at least one computing device associated with at least one user; wherein the quality score user interface comprising one or more user selectable entity records associated with the particular sub-population; wherein user selection of one or more user selectable entity records produces an interface component displaying: i) the quality score of the particular sub-population associated with the one or more user selectable entity records, and ii) a label identifying the particular sub-population associated with the one or more user selectable entity records.

The systems and methods of the present disclosure further include generating, by the at least one processor, a recommendation to market financial services to entities of the particular sub-population wherein the quality score exceeds the predetermined statistical value threshold.

The systems and methods of the present disclosure further include wherein the plurality of normal distributions comprises five normal distributions.

The systems and methods of the present disclosure further include generating, by the at least one processor, a first normal distribution around a first fixed position in the series of activity-related quantity indices; and generating, by the at least one processor, at least four additional normal distributions according to expectation-maximization of a mean value of each additional normal distribution of the at least four additional normal distributions.

The systems and methods of the present disclosure further include wherein the Bayesian model comprises a variational inference mean field approximation.

The systems and methods of the present disclosure further include wherein the series of activity-related quantity indices through time comprises a total consumer spend quantity at each merchant in the population for each predetermined time period.

The systems and methods of the present disclosure further include wherein each predetermined time period comprises a month.

The systems and methods of the present disclosure further include wherein the inferred mean quantity value comprises an inferred mean consumer spend quantity at each merchant in the particular sub-population in a predetermined time period.

The systems and methods of the present disclosure further include wherein the quality score comprises a mean consumer spend quantity categorization in one of ten groupings ranked by consumer spend quantities.

The systems and methods of the present disclosure further include generating, by the at least one processor, a purchase volume ranking of entities in the particular sub-population based on the mean consumer spend quantity categorization.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1A-20 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

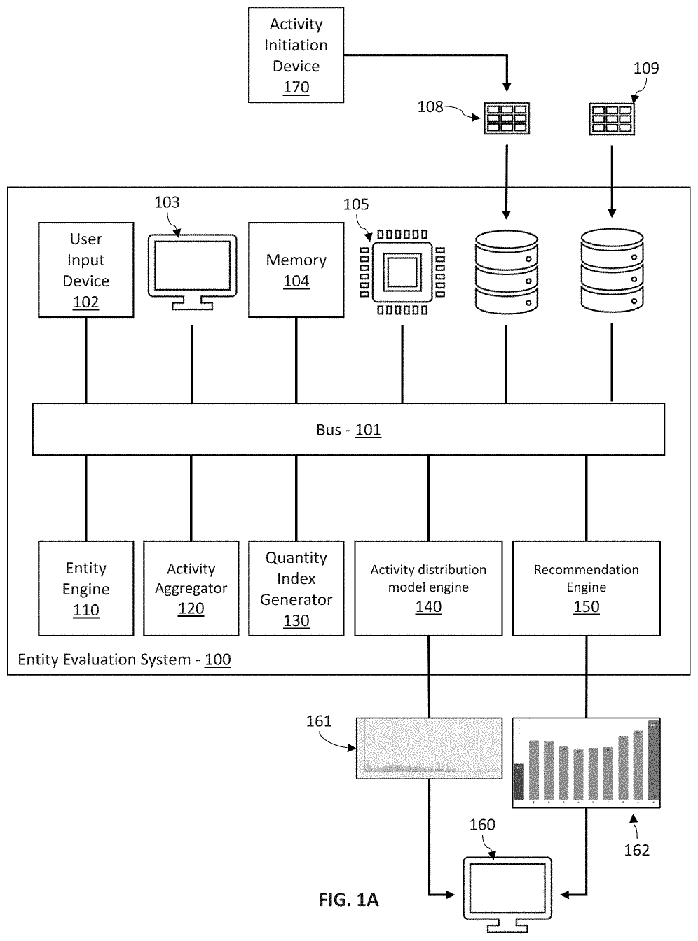

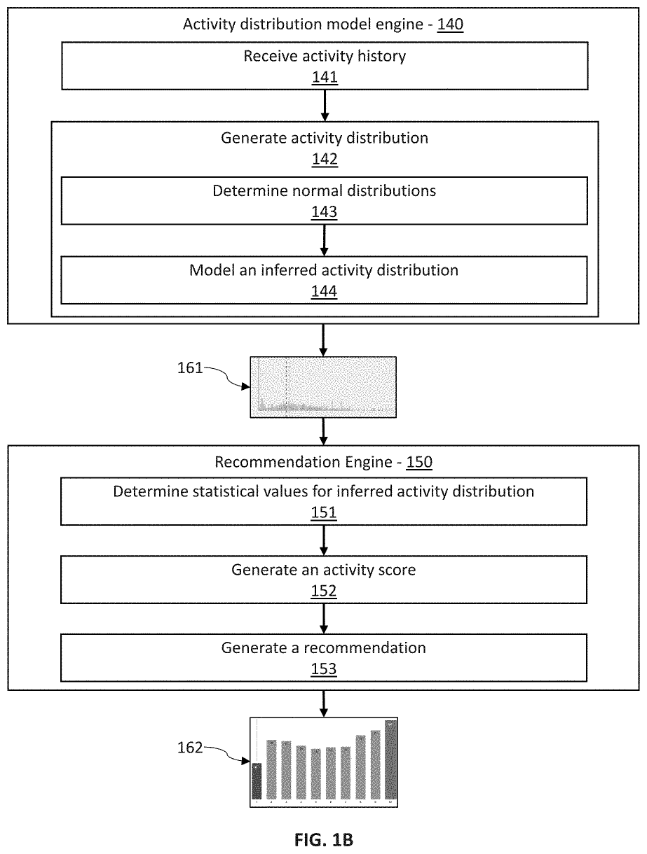

FIGS. 1A through 20 illustrate systems and methods of modelling and forecasting distributions of electronic activities with more efficient and more accurate technologies. The following embodiments provide technical solutions and technical improvements that overcome technical problems, drawbacks and/or deficiencies in the technical fields involving inefficient and inaccurate modelling of distributions based on numerical data associated with data records where the numerical data is scarce. As explained in more detail, below, technical solutions and technical improvements herein include aspects of improved activity modelling for more efficient and more accurate distribution modelling and forecasting according using improved modelling technologies.

In some embodiments, various performance metrics can be used as a proxy for evaluating the aggregate the numerical data from data records associated with electronic activity of an entity. However, data records are often insufficient or too irregular for a consistent statistical modelling, e.g., due to small sample sizes of data records. While there are some techniques for addressing data scarcity in statistical analysis, these techniques are resource intensive.

In some embodiments, the present disclosure provides improved processing systems that reduce data storage requirements for data records with numerical data by statistical modelling of the numerical data with reduced samples of data records, while improving processing times and processing resources via more efficient modelling techniques.

In some embodiments, the improved processing systems and techniques include a more efficient and faster model employing hierarchical Bayesian mixture models. Such models can take raw numerical data in small sample sizes to produce statistical models of the numerical data. For example, some modeling techniques such as Markov Chain Monte Carlo modelling methods can take weeks of processing time in order to produce a model of the numerical data. However, in some embodiments, the Bayesian mixture models can be combined with optimization algorithms to generate a model with greater accuracy in a few hours or less, thus improving the efficiency of the processing systems in such modelling applications.

In some embodiments, the statistical model may be employed to produce performance metrics and recommendations. For example, entities having high performance metrics based on modelled distributions may be recommended for certain activities or certain activities may be recommended to entities based on the performance metrics.

Based on such technical features, further technical benefits become available to users and operators of these systems and methods. Moreover, various practical applications of the disclosed technology are also described, which provide further practical benefits to users and operators that are also new and useful improvements in the art.

FIG. 1A is a block diagram of an illustrative computer-based system for entity resolution and activity aggregation and performance modelling in accordance with one or more embodiments of the present disclosure. FIG. 1B is a flowchart diagraming of an illustrative computer-based method for performance modelling in accordance with one or more embodiments of the present disclosure.

In some embodiments, an exemplary inventive entity evaluation system 100 includes a computing system having multiple components interconnected through, e.g., a communication bus 101. In some embodiments, the communication bus 101 may be a physical interface for interconnecting the various components, however in some embodiments, the communication bus 101 may be a network interface, router, switch, or other communication interface. The entity evaluation system 100 may receive a first set of records including data records 108 having numerical data associated with entities, e.g., electronic activity-related quantities and values associated with the entities. In some embodiments, the entity evaluation system 100 may also receive a second set of records including entity records 109 for the entities, and the various components may interoperate to matching data items from each set of records and generate an evaluation and characterization of each entity included in the data records 108 and/or the entity records 109. In some embodiments, the evaluation and characterization may include determining a numerical data item, e.g., associated with electronic activities recorded by the data records 108, including a quantity value associated with each data record 108, associating the quantity values with an entity and aggregating the total value for each entity to generate an electronic activity index to characterize each entity.

In some embodiments, the data records 108 may be received, e.g., in real-time, in batches, as a continuous stream, or according to any other suitable record communication methodology, via one or more activity initiation devices 170. In some embodiments, a user may execute electronic activities by employing the one or more activity initiation devices 170. Records of the electronic activities may be communicated to the data history database 106 to compile the set of data records. In some embodiments, each data record 108 may include data identifying an entity with which the user has interacted in executing each electronic activity. Accordingly, the data records 108 may be matched up to entities recorded in the entity records 109.

In some embodiments, the entity evaluation system 100 may include a processor 105, such as, e.g., a complex instruction set (CISC) processor such as an x86 compatible processor, or a reduced instruction set (RISC) processor such as an ARM, RISC-V or other instruction set compatible processor, or any other suitable processor including graphical processors, field programmable gate arrays (FPGA), neural processors, etc.

In some embodiments, the processor 105 may be configured to perform instructions provide via the communication bus 101 by, e.g., accessing data stored in a memory 104 via the communication bus 101. In some embodiments, the memory 104 may include a non-volatile storage device, such as, e.g., a magnetic disk hard drive, a solid state drive, flash memory, or other non-volatile memory and combinations thereof, a volatile memory such as, e.g., random access memory (RAM) including dynamic RAM and/or static RAM, among other volatile memory devices and combinations thereof. In some embodiments, the memory 104 may store data resulting from processing operations, a cache or buffer of data to be used for processing operations, operation logs, error logs, security reports, among other data related to the operation of the entity evaluation system 100.

In some embodiments, a user or administrator may interact with the entity evaluation system 100 via a display 103 and a user input device 102. In some embodiments, the user input device 102 may include, e.g., a mouse, a keyboard, a touch panel of the display 103, motion tracking and/or detecting, a microphone, an imaging device such as a digital camera, among other input devices. Results and statuses related to the entity evaluation system 100 and operation thereof may be displayed to the user via the display 103.

In some embodiments, the data history database 106 may communicate with the entity evaluation system 100 via, e.g., the communication bus 101 to provide the data records 108. In some embodiments, the data records 108 may include records having data items associated with entities, such as, e.g., commercial entities, including merchants, industrial entities, firms and businesses, as well as individuals, governmental organizations, or other entities.

In some embodiments, an entity database 107 may communicate with the entity evaluation system 100 to provide entity records 109 via, e.g., the communication bus 101. In some embodiments, the entity records 109 may include entity records identifying entities, such as, e.g., commercial entities, including merchants, industrial entities, firms and businesses, as well as individuals, governmental organizations, or other entities that are the same or different from the first entities. In some embodiments, the entity records 109 include records of, e.g., each entity in a geographic area, each entity in a catalogue or database or other grouping. For example, the entity database 107 may provide entity records 109 for all entities in, e.g., a particular town, a particular city, a particular state, a particular region, a particular country, or other geographic area. In some embodiments, the entity database 107 may provide entity records 109 for all entities related to a particular activity type, having a particular size, or other subset. In some embodiments, the entity database 107 may provide entity records 109 for all known entities, or for all known entities satisfying a user configured categorization.

In some embodiments, the entity evaluation system 100 may use the data records 108 and the entity records 109 to evaluate each entity identified in the entity records 109. Accordingly, in some embodiments, a set of components communicate with the communication bus 101 to provide resources for, e.g., matching data records 108 with entity records 109, establishing activities attributable to each entity, and generating an index to characterize each entity.

In some embodiments, the data records 108 and the entity records 109 include raw data records from the collection of entity-related data records. As such, the data items from the data records 108 and the entity records 109 may include, e.g., a variety of data formats, a variety of data types, unstructured data, duplicate data, among other data variances. Thus, to facilitate processing and using the data for consistent and accurate results, the data may be pre-processed to remove inconsistencies, anomalies and variances. Thus, in some embodiments, pre-processing may be performed to ingest, aggregate, and/or cleanse, among other pre-processing steps and combinations thereof, the data items from each of the data records 108 and the entity records 109.

In some embodiments, pre-processing may include compiling the data records 108 into a single structure, such as, e.g., a single file, a single table, a single list, or other data container having consistent data item types. For example, each data record may be added to, e.g., a table with data items identified for each of, e.g., a date, a first entity, an entity, an activity-related quantity, among other fields. The format of each field may be consistent across all records after pre-processing such that each record has a predictable representation of the data recorded therein.

Similarly, the entity records 109 may be compiled into a single structure, such as, e.g., a single file, a single table, a single list, or other data container having consistent data item types. For example, each entity record may be added to, e.g., a table with data items identified for each of, e.g., an entity, among other fields. The format of each field may be consistent across all records after pre-processing such that each record has a predictable representation of the data recorded therein.

In some embodiments, the structures containing each of the pre-processed data records and the pre-processed entity records may be stored in, e.g., a database or a storage, such as, e.g., the memory 104, or other storage.

In some embodiments, an entity engine 110 receives the data records 108 and the entity records 109 and based on the data items represented therein, match each entity record 109 to related data records 108 based on, e.g., similarity. In some embodiments, the entity engine 110 may include, e.g., a memory having instructions stored thereon, as well as, e.g., a buffer to load data and instructions for processing, a communication interface, a controller, among other hardware. A combination of software and/or hardware may then be implemented by the entity engine 110 in conjunction with the processor 105 or a processor dedicated to the entity engine 110 to implement the instructions stored in the memory of the entity engine 110.

In some embodiments, similarity or relatedness of the data records 108 to each entity record 109 may be determined by the entity engine 110 according to a matching algorithm.

In some embodiments, the entity engine 110 utilizes a machine learning model to compare the data items of the data records 108 with the data items of each entity record 109 to generate a probability of a match. Thus, in some embodiments, the entity engine 110 utilizes, e.g., a classifier to classify entities and matches based on a probability. In some embodiments, the classifier may include, e.g., random forest, gradient boosted machines, neural networks including convolutional neural network (CNN), among others and combinations thereof. Indeed, in some embodiments, a gradient boosted machine of an ensemble of trees is utilized. Such models may capture a non-linear relationship between transactions and merchants, thus providing accurate predictions of matches. In some embodiments, the classifier may be configured to classify a match where the probability of a match exceeds a probability of, e.g., 90%, 95%, 97%, 99% or other suitable probability based on the respective data entity feature vectors.

However, matching the data records 108 to the associated entity records 109 may be a processor intensive and resource intensive process. To reduce the use of resources, instead or in combination with machine learning, the entity engine 110 may compare the first data entity feature vectors with each second data entity feature vector using, e.g., a Heuristic search, a Euclidean distance, a Cosine Similarity, a Pearson's Correlation Coefficient, a Jaccard Similarity, or other similarity algorithm.

In some embodiments, for example, the entity engine 110 may match data records 108 to each entity record 109 using, e.g., a heuristic search. In some embodiments, the heuristic search may compare each data record 108 to each entity record 109 to compare, e.g., an entity data item of the first record to an entity record identifier data item representing an entity record identifier of each entity record and determines potential matches based on the distance of pairs of values representing the data items. Other or additionally data items of each of the data records 108 and the entity records 109 may be incorporated to determine potential matches.

In some embodiments, each data record 108 matching to an entity record 109 may be represented in, e.g., a table, list, or other entity resolution data structure. For example, the entity engine 110 may produce a table having a column for the entity records 109 with each entity record 109 being listed in a row. The table may include one or more additional columns to list the matching data records 108 in row with each entity record 109.

In some embodiments, an activity aggregator 120 receives the data records 108 matched to each of the matching entity records 109 as represented in, e.g., the entity resolution data structure.

In some embodiments, the activity aggregator 120 may include, e.g., a memory having instructions stored thereon, as well as, e.g., a buffer to load data and instructions for processing, a communication interface, a controller, among other hardware. A combination of software and/or hardware may then be implemented by the activity aggregator 120 in conjunction with the processor 105 or a processor dedicated to the activity aggregator 120 to implement the instructions stored in the memory of activity aggregator 120.

In some embodiments, each data record 108 may include numerical data, such as, e.g., an activity-related quantity, including, e.g., a dollar amount, a tally, a frequency, a duration, or other activity-related quantity represented by a numerical data item for an electronic activity, such as, e.g., electronic transaction, social media post, login event, internet message, text message, email, or others and combinations thereof. In some embodiments, the activity aggregator 120 sums the activity-related quantities represented by the matching data records 108 for each entity record 109. Thus, in some embodiments, the activity aggregator 120 aggregates the activity-related quantities resulting from entity activity for each entity of the entity records 109. Thus, the activity aggregator 120 may determine an aggregate activity-related quantity associated with activities of each entity of the entity records 109.

In some embodiments, the activity-related quantities associated with each entity record 109 may be aggregated on a periodic basis to construct a history of activity-related quantities through time at intervals corresponding to periods of the periodic basis. For example, activity-related quantities for each entity record 109 may be aggregated for every, e.g., day, week, month, quarter year, half year, year, or other suitable period.

In some embodiments, a quantity index generator 130 receives the aggregates for each entity record 109. In some embodiments, the quantity index generator 130 may include, e.g., a memory having instructions stored thereon, as well as, e.g., a buffer to load data and instructions for processing, a communication interface, a controller, among other hardware. A combination of software and/or hardware may then be implemented by the quantity index generator 130 in conjunction with the processor 105 or a processor dedicated to the quantity index generator 130 to implement the instructions stored in the memory of the quantity index generator 130.

In some embodiments, the quantity index generator 130 utilizes the aggregate activity-related quantities to generate an activity-related quantity index that represents an evaluation of the activity of each entity. For example, each entity can be compared to other known entities with known activities and activity-related quantities to determine a ranking, a risk level, or other measure of the activity-related quantities.

In some embodiments, the quantity index generator 130 may be updates in a temporally dynamic fashion, e.g., daily, weekly, monthly or by another period based on, e.g., user selection via the user input device 102. Thus, the data records 108 and the entity records 109 may be updated with new records on a periodic basis or in real-time, and the entity evaluation system 100 may match the records and aggregate activities as described above according to the selected period. In some embodiments, the activity-related quantity index may be updated each period based on the total set of records, however in some embodiments, each period results in a new activity-related quantity index representative of that period. In some embodiments, the new or updated activity-related quantity index for each period may be logged and/or recorded in, e.g., the memory 104 to construct a data record history for each entity including a historical tracking of entity activities.

In some embodiments, a user may select to filter entities, e.g., according to a forecast of an activity-related quantity index distribution (“index distribution”) for a particular entity or sub-population of entities, e.g., via the user input device 102, for selection, grouping, evaluation and characterization. In some embodiments, the sub-population may be a segment of entities within a hierarchical segmentation scheme. For example, entities may be business within industries, such that entities can be categorized according to an entity type (e.g., industry (e.g., based on the North American Industry Classification System (NAICS), the Standard Industrial Classification Codes (SIC Codes)), or other custom or standardized codes and combinations thereof, geographic location, or other segmentation and various combinations thereof.

In some embodiments, the segmentation of entities may include a hierarchy of segments or categories. For example, a lowest level in the hierarchy may include segmentation according to individual entities, while a highest level in the hierarchy may include a national segmentation, regional segmentation, general type segmentation, specific type segmentation, or other segmentation having a relatively low number of segments relative to the rest of the levels in the hierarchy. In some embodiments, the hierarchy may include one highest level and one lowest level. In some embodiments, there are one or more levels of segmentation between the highest level and lowest level in the hierarchy, where the lower the level indicates a greater granularity or specificity of the segmentation.

In some embodiments, an index distribution model engine 140 may be employed to improve the scoring and ranking of entity records by providing a mechanism to compensate for a scarcity in activity-related data of the data records 108 over any given time period. In some embodiments, the index distribution model engine 140 may ingest the data records 108 and the activity-related quantity index for each entity to model and forecast activity-related performance for one or more entities or sets of entities. In some embodiments, the modelling is performed for entities within the sub-population according to the activities across entities within the population. However, the sub-populations of entities, particularly in the lowest level of the hierarchy of segmentation, may have few or inconsistent amounts of entities. Thus, forming a distribution of the activity-related quantity indices within the sub-population may result in inconsistent or unreliable metrics.

Accordingly, in some embodiments, the index distribution model engine 140 may access or otherwise receive at block 141 a data record history of the activities across entities in the population of entities for which the sub-population is a part based on the hierarchical level of the segmentation. In some embodiments, the data record history include the data records 108 for each entity in the population as well as the activity-related quantity index for each entity for a particular time period (e.g., a particular week, month, quarter, half or year, or other suitable period). In some embodiments, the activity-related quantity index for each entity may be the activity-related quantity index for the particular period, or across multiple periods through time.

In some embodiments, the population may include one or more additional sub-populations corresponding to lower levels in the hierarchical levels of segmentation in addition to the selected sub-population. For example, the population may be associated with a nationwide group of entities in a particular general entity type, while the sub-populations may include, e.g., state by state populations of the entities in the particular general entity type, a nationwide population in a particular specific entity type within the general entity type, and state by state populations of entities within the particular specific entity type, among other sub-populations. In some embodiments, the more granular, or lower level segmentation of entities within the population reduces the number of entities associated therewith. As a result, there may not be enough data to construct an accurate model according to the data record history of a sub-population within the population. Accordingly, in some embodiments, the index distribution model engine 140 may infer a statistical distribution of activity-related quantity indices for entities within the sub-population.

In some embodiments, the index distribution model engine 140 may employ the activity-related quantity indices to generate an index distribution at block 142 for the sub-population. In some embodiments, to enable inferring the index distribution, the index distribution model engine 140 may determine a mixture of normal distributions at block 143 where each normal distribution models a respective sub-distribution of the selected sub-population. In some embodiments, the actual distribution representing the activity-related quantity indices for entities in the sub-population may be too complex for a single distribution curve. Thus, the mixture of normal distributions allows for the index distribution model engine 140 to fit curves to sub-distributions within the sub-population, thus enabling a more sophisticated modelling of the true distribution.

For example, in some embodiments, each additional sub-population and the population itself may have an associated normal distribution, e.g., according to a probability density function. For example, where a user, e.g., via the user input device 102, selects the sub-population, the index distribution model engine 140 may automatically form normal distributions as described above for each level in the hierarchy for which the sub-population is included.

In some embodiments, each normal distribution may be fit to an associated population or additional sub-population and centered around a fixed position for the associated population or additional sub-population. For example, each normal distribution may be centered around the mean activity-related quantity index and standard deviation of the activity-related quantity indices for the population and each additional sub-population. For example, each normal distribution may be centered around the mean activity-related quantity index of entities within an associated additional sub-population, and having a distribution shaped according to the standard deviation of the activity-related quantity indices of the entities within the associated additional sub-population. In some embodiments, the normal distributions may be fit to each associated additional sub-population according to, e.g., expectation-maximization of a mean value. As a result, the normal distributions may be dynamically and adjustable fit to entities of the respective additional sub-populations.

In another example, each normal distribution may be a fixed normal distribution centered around a fixed mean with a fixed standard deviation. In some embodiments, a normal distribution for an artificial sub-population be centered around a fixed position. For example, the artificial sub-population may approximate a sub-population having a zero activity-related quantity index. Accordingly, the artificial sub-population may be represented with a normal distribution centered around a mean activity-related quantity index of zero with a standard deviation of zero. In some embodiments, each normal distribution may then be updated a fit to model the selected sub-population given the activity-related quantity indices for the broader sub-populations and the population on the whole at higher levels in the hierarchy.

In some embodiments, alternative modelling techniques to compensate for data sparsity require large numbers of simulations to infer data points. For example, Monte Carlo techniques, such as Markov Chains, as well as other Bayesian modelling techniques must perform large-scale, processor intensive simulations when operating on databases. In some embodiments, to reduce or eliminate the need for such extensive simulations, a hierarchical Bayesian mixture model using the normal distributions described above on can leverage the already existing data to infer the distribution of sub-population without the simulations. As a result, database operations are more efficient, reducing processing times from the order of weeks to the order of hours.

In some embodiments, any suitable number of normal distributions may be employed. For example, 1, 2, 3, 4, 5 or more normal distributions may be employed. In some embodiments, there may be 4 normal distributions associated with 4 additional sub-populations (e.g., including the population) and the one normal distribution for the one artificial sub-population. However, more or fewer additional sub-populations may be employed in addition to the artificial sub-population (e.g., 2, 3, 5, 6, or more).

In some embodiments, an index distribution for a particular sub-population, such as, e.g., the selected sub-population at the lowest level of the hierarchy of segmentation may be inferred based on a mixture of the normal distributions for the additional sub-populations in the hierarchy above the lowest level. In some embodiments, the index distribution model engine 140 may model, at block 144, an inferred index distribution 161 for the selected sub-population using the mixture of normal distributions described above.

In some embodiments, to model the inferred index distribution 161, the index distribution model engine 140 may employ a Bayesian model, such as, e.g., a Bayesian linear regression model or other suitable Bayesian inference-based model. Bayesian inference-based models according to aspects of embodiments of the present disclosure may be configured to utilize one or more exemplary AI or machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values, functions and aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the index distribution model engine 140 may train parameters of the Bayesian model to create a probability density function from the parameters that represents an inferred index distribution 161 for a next time period (e.g., a next week, a next month, a next quarter, a next half, a next year, etc.). The inferred index distribution 161 approximates a true distribution of the activity-related quantity indices of entities in the selected sub-population of entities despite small samples sizes in the selected sub-population. In some embodiments, an approximation technique may be employed to iteratively converge on probability density function parameters that is the most likely approximate of a true distribution of activity-related quantity indices for the sub-population.

Accordingly, in some embodiments, the approximation technique may test a probability of a latent variable including an unobserved activity-related quantity index in the selected sub-population against a normal distribution of one of the additional sub-populations. Based on the probability, the parameters of the inferred index distribution 161 may be updated. In some embodiments, the parameters may be updated according to, e.g., a variational inference technique, such as, e.g., a mean field algorithm, or an expectation-maximization technique, such as, e.g., maximum a posteriori estimation, or any other suitable approximation algorithm. In some embodiments, to facilitate the efficient training of the inferred index distribution 161, the index distribution model engine 140 may utilize a variational inferencing mean field to determine the probability density function of the inferred index distribution 161 from the mixed model. In some embodiments, the combination of hierarchical Bayesian mixture modelling with variational inferencing mean fields can reduce runtime in formulating the approximation of the inferred index distribution 161 from weeks to hours.

In some embodiments, the index distribution model engine 140 may output the inferred index distribution 161 to, e.g., display 103 or to another user computing device 160. In some embodiments, outputting the inferred index distribution 161 may include, e.g., causing the display 103 or a display of another user computing device 160 to display the inferred index distribution 161 in a user interface in response to the user's selection of the selected sub-population. In some embodiments, outputting the inferred index distribution 161 may include, e.g., storing the inferred index distribution 161 in a sub-population index distribution storage, e.g., in the memory 104 or a database (e.g., the data history database 106 or entity database 107 or other database).

In some embodiments, the index distribution model engine 140 outputs the inferred index distribution 161 to a recommendation engine 150, either directly or indirectly via the sub-population index distribution storage or other means. In some embodiments, the recommendation engine 150 may use the inferred index distribution to compare the sub-population to other sub-populations and generate a recommendation.

In some embodiments, as the basis for the comparison, the recommendation engine 150 may user the inferred index distribution 161 to determine statistical values, at block 151, representative of the activity-related quantity indices of the entities in the selected sub-population. In some embodiments, the recommendation engine 150 may determine an inferred mean quantity value and an inferred standard deviation mean quantity value of the inferred index distribution 161. However, in some embodiments, the recommendation engine 150 may determine, e.g., the median, precision, variance, range, or other statistical values and combinations thereof.

In some embodiments, the statistical values may then be compared to the statistical values representing the activity-related quantity indices of entities in other sub-populations, including generating a quality score at block 152 for the selected sub-population. In some embodiments, the quality score may serve a performance metric relative to other sub-populations of entities to assess the performance and health of the entity activities.

In some embodiments, the quality score may include, e.g., a ranking or relative score relative to each other sub-population. In some embodiments, the quality score may include a grouping into an index ranking relative to other sub-populations. For example, in some embodiments, the recommendation engine 150 establishes ten groupings (deciles) and ranks each sub-population based on the activity mean of each sub-population, the inferred activity mean of the selected sub-population as well as any other inferred activity means in the sub-population index distribution storage. In some embodiments, the ranking is then grouped in the ten equally sized deciles, and the quality score is the rank of the decile in which the selected sub-population is grouped. However, in some embodiments, the quality score may be the rank before grouping into deciles, or the inferred activity mean itself, or other suitable metric indicative of the activity-related quantity indices of the entities of the selected sub-population. In some embodiments, greater than or fewer than ten groupings may be employed. For example, the sub-populations may be grouped into, e.g., five, six, seven, eight, nine, ten, eleven, twelve, fifteen, twenty, twenty five or more groupings.

In some embodiments, the quality score may be correlated to a projected metric, such as a correlation to a total activity quantity for the coming period for which the inferred index distribution 161 is forecasted. In some embodiments, the recommendation engine 150 uses the quality score to assess the projected metric and make a recommendation 162 to the user at block 153. For example, the recommendation engine 150 may compare the quality score to a predetermined threshold value. The recommendation engine 150 may generate a recommendation based on the quality score exceeding or falling below the predetermine threshold value, such as, e.g., a top 3 decile, bottom 3 decile, top decile, bottom decile, or predetermined threshold value based on the inferred mean activity-related quantity index, among other threshold values.

In some embodiments, the recommendation engine 150 may cause a display (e.g., display 103 other one or more user computing devices and combination thereof) to display the recommended action 162 using, e.g., a quality score user interface. The quality score user interface includes one or more user selectable entity records associated with the subset of entities. In some embodiments, user selection of one or more user selectable entity records produces an interface component displaying, e.g., a quality score of the sub-population associated with the one or more user selectable entity records, a label identifying the sub-population associated with the one or more user selectable entity records, and the recommended action associated with the one or more user selectable entity records. In some embodiments, the quality score includes, e.g., the quality score associated with the sub-population.

In some embodiments, the recommendation engine 150 may further employ the activity-related quantity index and/or the inferred index distribution 161 and/or the inferred mean activity-related quantity index to make recommendations concerning each entity. Thus, each respective entity record 109 may be categorized based on each respective associated activity-related quantity index according to a set of predetermined activity-related quantity index ranges based on multiple threshold levels of activity. The categorizations may then be used to match each respective entity associated with each respective entity record 109 to an attribute indicative of a recommended action.

In one possible example, the activities may be transaction activities, such as consumer transaction records from credit card transactions, and the entities may be merchants participating in those transactions. Accordingly, industries (e.g., according to the NAICS) by state may be compared with each other for spend indices representing the consumer spend towards the merchants in each industry-state sub-population. For example, a mean consumer spend index can be used to compare the projected performance of each industry-state sub-population of merchants in the United States for a coming period.

In this example, the quality score may be indicative of financial performance of entities in the selected sub-population. Where the sub-population is grouped with, e.g., the top five deciles based on the inferred mean activity-related quantity index, top four deciles, top three deciles, top two deciles, top decile, or other threshold, the recommendation engine 150 may be triggered to provide a recommended action of a “high projected purchase volume” or “high probability to pay in full” and recommend to market financial services to entities in the selected sub-population. Conversely, where the sub-population is grouped with, e.g., the bottom five deciles based on the inferred mean activity-related quantity index, bottom four deciles, bottom three deciles, bottom two deciles, bottom decile, or other threshold, the recommendation engine 150 may be triggered to provide a recommended action of a “high risk of delinquency” and recommend to not pursue marketing towards entities in the sub-population. Other recommendations are contemplated, including, e.g., adjustments to credit lines and limits, among other marketing and financial services recommendations.

In this example, the recommendation engine 150 may generate marketing recommendations for financial products in direct mailing marketing, such as, e.g., lines of credit, loans, mortgages, investment, etc. For example, the recommendation engine 150 may compare an entity's activity-related quantity index with financial products to, e.g., target active businesses based on a threshold level of activity, identify product fit over time and/or relative to other businesses based on the amount of business conducted, and identify unsuitable businesses based on activity being below a threshold level according to the activity-related quantity index. Underwriting can be facilitated using the activity-related quantity index from the recommendation engine 150. For example, in some embodiments, an activity-related quantity index of a customer from the entity records may be approved or disapproved based on, e.g., a threshold activity-related quantity index assigned to a product or service for which the customer is applying. Similarly, customer management recommendations may be made by the recommendation engine 150. For example, wherein the entities are merchants, the recommendation engine 150 may utilize the activity-related quantity index to, e.g., offer products and terms to existing customers, offer upgrade opportunities where aggregate activity has shown consistent increases, identify business segments for each merchant based on activity amounts to customize marketing strategies and increase engagement with the financial products, among other customer management recommendations. In some embodiments, the offers may be determined by categorizing each respective entity record of a set of entity records into a respective customer category based on each respective activity-related quantity index associated with each respective entity record of the set of entity records. Each activity-related quantity index range can be one of a set of predetermined activity-related quantity index ranges that relate to a set of products identified as appropriate for that activity-related quantity index. Using the categorizations, modifications to products associated with each entity may be suggested to the respective entity to better match a customer to a product as the customer's business grows or recedes.

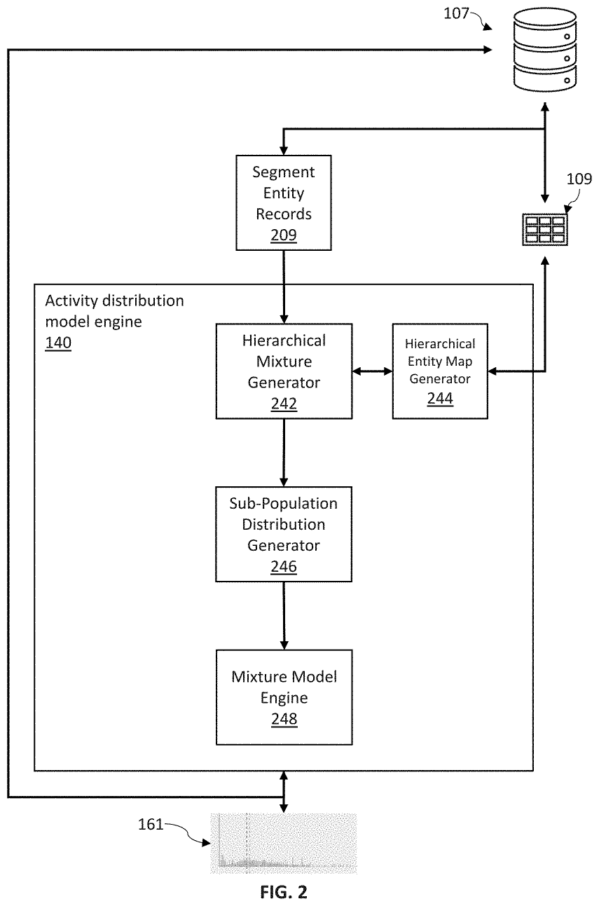

FIG. 2 depicts a block diagram of an activity distribution model engine 140 according to aspects of some embodiments of the present disclosure.

In some embodiments, the activity distribution model engine 140 may interface with the entity database 107 to access entity records 109, including, e.g., activity-related quantity indices for each entity. In some embodiments, the activity distribution model engine 140 includes software and/or hardware components to leverage the entity records 109 to model an inferred index distribution 161 for a selected segment of entity records 209, e.g., ranking, filtering, categorizing or other application or any combination thereof for entity records 109.

In some embodiments, the activity distribution model engine 140 may ingest the selected entity record 209 and determine a hierarchical mixture of related entity records 109 using a hierarchical mixture generator 242. In some embodiments, to facilitate hierarchical mixture modelling, the hierarchical mixture generator 242 may identify category or type attributes or a combination of category and type attributes that indicate a category of the entity associated with the selected segment of entity record 209 and a type of the entity associated with the selected segment of entity records 209, respectively.

In some embodiments, based on the category and/or type attribute of the selected segment of entity records 209, the hierarchical mixture generator 242 may identify the entity records 109 associated with the category and/or type attribute, e.g., using a hierarchical map object defining a hierarchy of sub-populations of a population of entities according to, e.g., a hierarchy of categories and/or types. In some embodiments, the activity distribution model engine 140 may include a hierarchical entity map generator 244 to ingest the entity records 109 from the entity database 107 and construct the hierarchical map object using the category and/or type attribute of each entity record 109.

In some embodiments, each entity record 109 may have multiple category and/or type attributes specifying various segments of the population of entities to which each entity record 109 belongs, such as, e.g., geographic area (continent, country, domestic region, international region, state, territory, county, town, city, district, neighborhood, etc.), entity type (e.g., person, company, government, educational institution, public school, private school, non-profit, etc.), entity sub-type (e.g., type of company, type of market or product or service, K-12, higher or graduate education, etc.), among other segments and sub-segments. Based on the relationships between the category and/or type attribute types between each entity record 109, the hierarchical entity map generator 244 may generate the hierarchical map object representing connections between each entity record 109 for commonalities across segments and sub-segments of the population.

In some embodiments, the hierarchical map object may be pre-generated and stored in the entity database 107. The hierarchical entity map generator 244 may periodically update the hierarchical map object with new entity records 109, such as updating the hierarchical map object every, e.g., day, night, week, two weeks, month, year, or any combination and/or multiple thereof

In some embodiments, the hierarchical entity map generator 244 may update the hierarchical map object upon request by the hierarchical mixture generator 242. In some embodiments, the request may be triggered by the receipt of the selected segment of entity records 209.

In some embodiments, the hierarchical mixture generator 242 may use the hierarchical map object to identify each hierarchical population level including hierarchical population levels above the selected segment entity records 209. In some embodiments, the selected segment of entity records 209 may include a category and/or type attribute specifying a segment of the population that is within a broader segment of the population, e.g., specifying a sub-population of a larger population. The hierarchical mixture generator 242 may identify each larger population for which the selected segment of entity records 209 is a sub-population, including the next larger population for which those identified larger populations are a sub-population. Thus, the hierarchical mixture generator 242 identifies the position of the selected segment of entity records 209 with a hierarchical scheme of the population of entity records 109 according to the hierarchical map object.

In some embodiments, the hierarchical mixture generator 242 may then define a hierarchical mixture for use in inferring the inferred index distribution 161. In some embodiments, the sub-population distribution generator 246 may use the hierarchical mixture to determine for each sub-population a distribution of activity-related quantity indices (e.g., the index distributions).

Accordingly, in some embodiments, the sub-population distribution generator 246 may access or otherwise receive a data record history of the activities across entities in the population of entities for which the sub-population is a part based on the hierarchical mixture. In some embodiments, the data record history include the data records 108 for each entity in the population as well as the activity-related quantity index for each entity for a particular time period (e.g., a particular week, month, quarter, half or year, or other suitable period). In some embodiments, the activity-related quantity index for each entity may be the activity-related quantity index for the particular period, or across multiple periods through time.

In some embodiments, the sub-population distribution generator 246 may employ the activity-related quantity indices to generate an index distribution for the sub-population. In some embodiments, the sub-population distribution generator 246 may determine a mixture of normal distributions where each normal distribution models a respective sub-distribution of the hierarchical mixture. In some embodiments, the actual distribution representing the activity-related quantity indices for entities in the hierarchical mixture may be too complex for a single distribution curve. Thus, the mixture of normal distributions allows for the sub-population distribution generator 246 to fit curves to sub-distributions within each sub-population, thus enabling a more sophisticated modelling of the true distribution.

For example, in some embodiments, each additional sub-population and the population itself may have an associated normal distribution, e.g., according to a probability density function. Accordingly, the sub-population distribution generator 246 may automatically form normal distributions as described above for each level in the hierarchy of the hierarchical mixture.

In some embodiments, each normal distribution may be fit to an associated population or additional sub-population and centered around a fixed position for the associated population or additional sub-population. For example, each normal distribution may be centered around the mean activity-related quantity index and standard deviation of the activity-related quantity indices for the population and each additional sub-population. For example, each normal distribution may be centered around the mean activity-related quantity index of entities within an associated additional sub-population, and having a distribution shaped according to the standard deviation of the activity-related quantity indices of the entities within the associated additional sub-population. In some embodiments, the normal distributions may be fit to each associated additional sub-population according to, e.g., expectation-maximization of a mean value. As a result, the normal distributions may be dynamically and adjustable fit to entities of the respective additional sub-populations.

In another example, each normal distribution may be a fixed normal distribution centered around a fixed mean with a fixed standard deviation. In some embodiments, a normal distribution for an artificial sub-population be centered around a fixed position. For example, the artificial sub-population may approximate a sub-population having a zero activity-related quantity index. Accordingly, the artificial sub-population may be represented with a normal distribution centered around a mean activity-related quantity index of zero with a standard deviation of zero. In some embodiments, each normal distribution may then be updated a fit to model the selected sub-population given the activity-related quantity indices for the broader sub-populations and the population on the whole at higher levels in the hierarchical mixture.

In some embodiments, any suitable number of normal distributions may be employed. For example, 1, 2, 3, 4, 5 or more normal distributions may be employed. In some embodiments, there may be 4 normal distributions associated with 4 additional sub-populations (e.g., including the population) and the one normal distribution for the one artificial sub-population. However, more or fewer additional sub-populations may be employed in addition to the artificial sub-population (e.g., 2, 3, 5, 6, or more).

In some embodiments, a mixture model engine 248 may employ the sub-population distributions from the sub-population distribution generator 246 to model an inferred distribution based on the hierarchical mixture. In some embodiments, the mixture model engine 248 may utilize, e.g., a suitable probabilistic model for modelling a mixture of subpopulations within an overall population, without requiring that an observed data set should identify the sub-population to which any individual observation belongs. For example, the mixture model engine 248 may employ, e.g., a Bayesian mixture model, or other suitable mixture model.

In some embodiments, to model the inferred index distribution 161, the mixture model engine 248 may employ a Bayesian model, such as, e.g., a Bayesian linear regression model or other suitable Bayesian inference-based model. Bayesian inference-based models according to aspects of embodiments of the present disclosure may be configured to utilize one or more exemplary AI or machine learning techniques as described above.

In some embodiments, the mixture model engine 248 may train parameters of the Bayesian model to create a probability density function from the parameters that represents an inferred index distribution 161 for a next time period (e.g., a next week, a next month, a next quarter, a next half, a next year, etc.). The inferred index distribution 161 approximates a true distribution of the activity-related quantity indices of entities in the selected sub-population of entities despite small samples sizes in the selected sub-population. In some embodiments, an approximation technique may be employed to iteratively converge on probability density function parameters that is the most likely approximate of a true distribution of activity-related quantity indices for the sub-population.

In some embodiments, the mixture model engine 248 may output the inferred index distribution 161 to, e.g., display 103 or to another user computing device 160. In some embodiments, outputting the inferred index distribution 161 may include, e.g., causing the display 103 or a display of another user computing device 160 to display the inferred index distribution 161 in a user interface in response to the user's selection of the selected sub-population, or to the recommendation engine 150 or any other suitable output or any combination thereof. In some embodiments, outputting the inferred index distribution 161 may include, e.g., storing the inferred index distribution 161 in a sub-population index distribution storage, e.g., in the memory 104 or a database (e.g., the data history database 106 or entity database 107 or other database).

In some embodiments, the inferred index distribution 161 may characterize an inference of a true distribution of activity-related quantity indices for the selected segment of entity records 209. In some embodiments, the inferred index distribution 161 may therefore be used to generate at least one inferred statistical value indicative of the expected or predicted activity-related quantity indices for the present or next time period. In some embodiments, the activity distribution model engine 140 may therefore sort or filter entities and/or segments of entities based on the at least one inferred statistical value indicative of the expected or predicted activity-related quantity indices, such as, e.g., filtering by a mean activity-related quantity index, a median activity-related quantity index, a weighted mean activity-related quantity index, a weighted mean activity-related quantity index, a sum of activity-related quantity indices, or any other measure.

In some embodiments, the entity records 109 within the entity database 107 may be filtered based on whether the at least one inferred statistical value exceeds or does not exceed a threshold statistical value. In some embodiments, the threshold statistical value may be a predetermined threshold statistical value, the threshold statistical value may be user defined, dynamically adjusted to according to the at least one inferred statistical value of each sub-population, or may take any other suitable form or any combination thereof. Thus, the activity distribution model engine 140 may provide an efficient tool for filtering and sorting entity records 109 within the entity database 107 for fast and efficient database management.

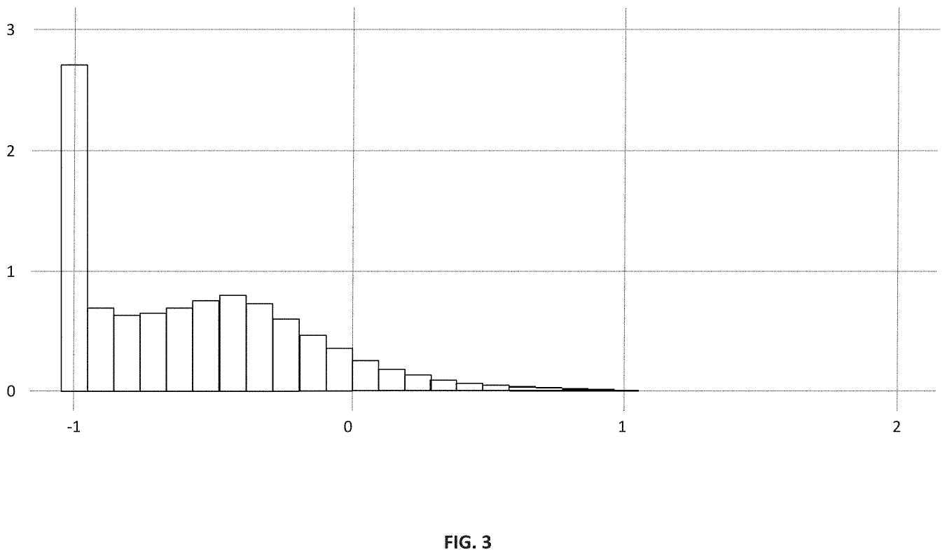

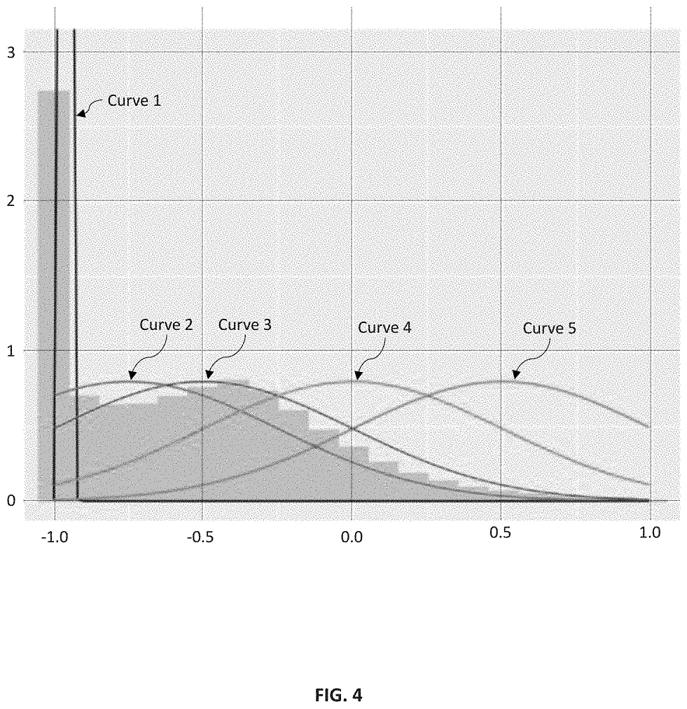

FIG. 3 depicts an example distribution of activity-related quantity scores in a sub-population of entities. The distribution includes a −1 inflated pattern showing 100% activity-related quantity loss (e.g., revenue loss or other loss) for some entities within the sub-population. FIG. 4 depicts example normal distribution curves for a mixture model to approximate an actual distribution of, e.g., the example distribution as shown in FIG. 2. The five normal distributions mixture model shows five curves (e.g., Curve 1, Curve, 2, Curve 3, Curve 4 and Curve 5) modelling the five normal distributions, include a −1 normal curve for the sub-population. This mixture model facilitates the use of optimizations that can scale up to big data and get results in a few hours to approximate the actual distribution of the sub-population.

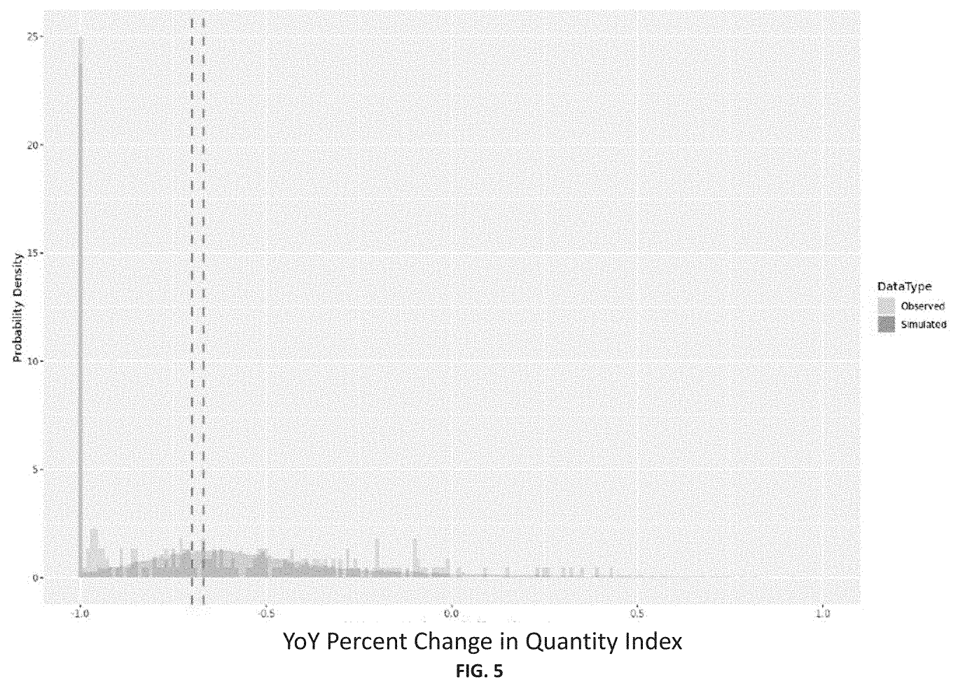

FIG. 5 depicts an observed distribution superimposed with a simulated distribution for a sub-population, where the distributions are represented as a probability density as a function of Year-over-Year (YoY) changes to the activity-related quantity scores. In this example, the sub-population includes the state-industry combination of entities including a first population segment. This sub-population includes 223 entities with an observed activity-related quantity index, for a sample size of 223. The observed median is measured to be −0.7 while the simulated median based on the simulated distribution is −0.67.

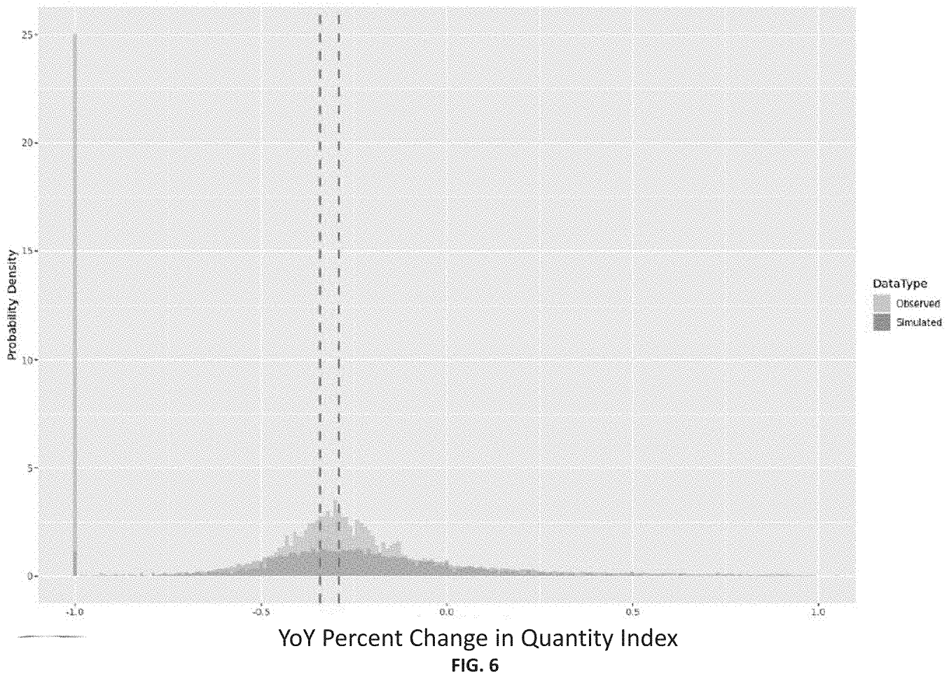

FIG. 6 depicts an observed distribution superimposed with a simulated distribution for a sub-population, where the distributions are represented as a probability density as a function of Year-over-Year (YoY) changes to activity-related quantity scores. In this example, the sub-population includes the state-industry combination of entities including a second population segment. This sub-population includes 2,053 entities with an observed activity-related quantity index, for a sample size of 2,053. The observed median is measured to be −0.29 while the simulated median based on the simulated distribution is −0.34.

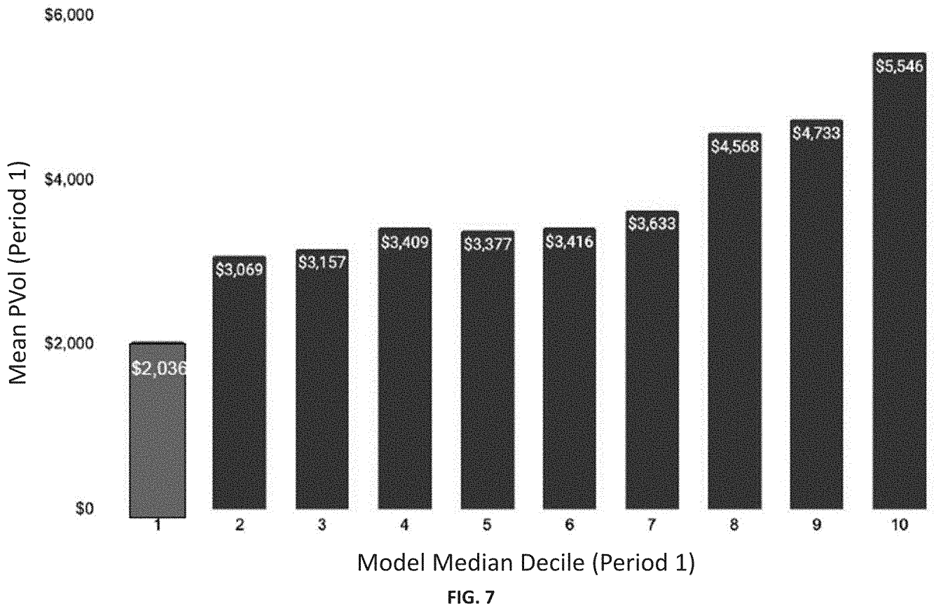

FIG. 7 depicts an example bar graph representing purchase volume of each decile of a population of entities in state-industry combination sub-populations. Each decile has been determined as described above according to the inferred index distribution 161. Each decile has been constructed according to a current period of time (Period 1) (e.g., a previous month) activity-related quantity indices, with each bar for each decile representing an aggregate activity quantity in Period 1 for the associated sub-populations of each decile. As shown, the decile is correlated with the aggregate activity quantity performance of the sub-populations.

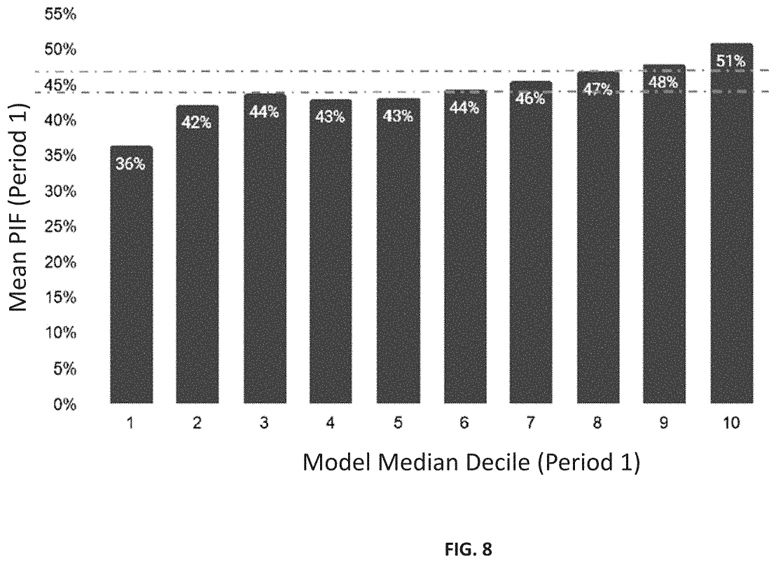

FIG. 8 depicts an example bar graph representing a performance metric (e.g., Paid-in-Full (PIF) rate or other risk metric) of each decile of a population of entities in state-industry combination sub-populations. Each decile has been determined as described above according to the inferred index distribution 161. Each decile has been constructed according to a Period 1 activity-related quantity indices, with each bar for each decile representing a Period 1 performance metric for the associated sub-populations of each decile. As shown, the decile is correlated with the performance metric of the sub-populations.

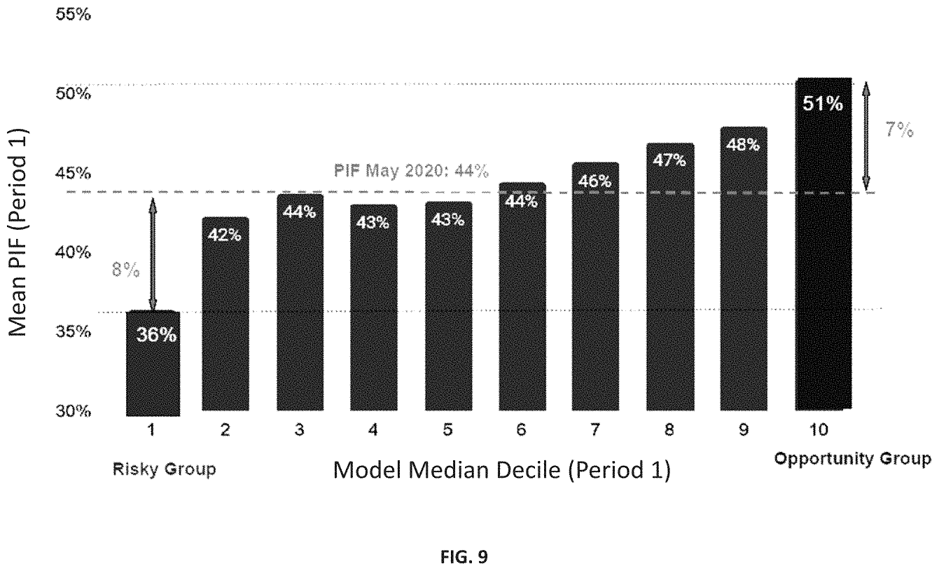

FIG. 9 depicts an example recommendation for a marketing opportunity and for a marketing risk according to the example bar graph of FIG. 7 representing a performance metric of each decile of a population of entities in state-industry combination sub-populations. Each decile has been determined as described above according to the inferred index distribution 161. Each decile has been constructed according to a Period 1 activity-related quantity indices, with each bar for each decile representing Period 1 performance metric for the associated sub-populations of each decile. As shown, the decile is correlated with the performance metric of the sub-populations.

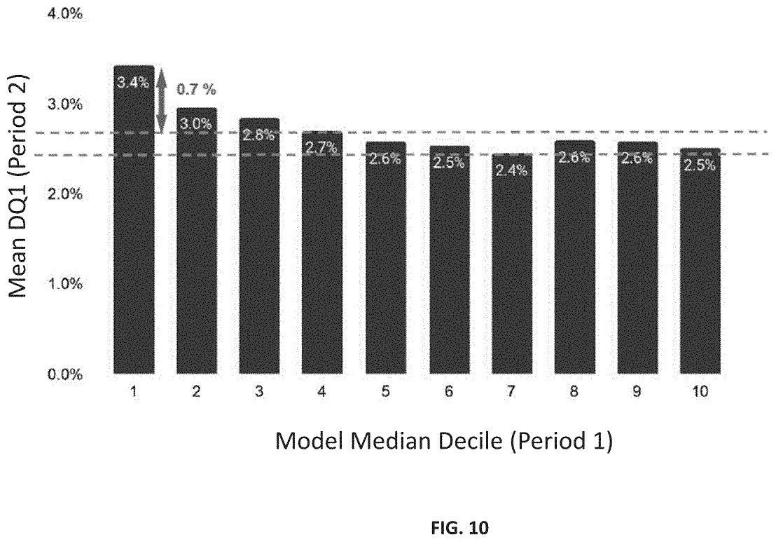

FIG. 10 depicts an example bar graph representing a risk metric (e.g., Delinquency (DQ 1-30) rate or other risk metric) of each decile of a population of entities in state-industry combination sub-populations. Each decile has been determined as described above according to the inferred index distribution 161. Each decile has been constructed according to a Period 1 activity-related quantity indices, with each bar for each decile representing a subsequent period (Period 2) risk metric for the associated sub-populations of each decile. As shown, the decile is correlated with the risk metric of the sub-populations.

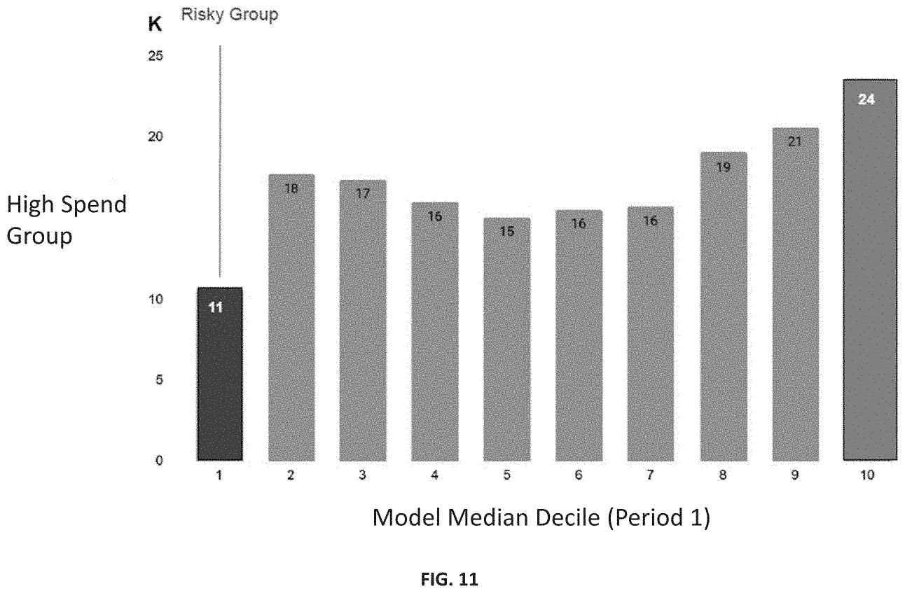

FIG. 11 depicts an example bar graph representing a highest performing subset of entities within each sub-population of each decile of a population of entities in state-industry combination sub-populations according to aggregate activity quantity. Each decile has been determined as described above according to the inferred index distribution 161. Each decile has been constructed according to a Period 1 activity-related quantity indices, with each bar for each decile representing a number of entities exceeding a predetermined aggregate activity quantity based on a Period 2 aggregate activity quantity for the associated sub-populations of each decile. As shown, the decile is correlated with a number of entities exceeding the predetermined aggregate activity quantity by sub-populations. A recommendation can be made based on the decile because it may be predictive of the chance of a sub-population having entities exceeding the predetermined aggregate activity quantity, where the number one decile (lowest performing) is a risky group of entities, while the number ten decile (top performing) represents an opportunity group.

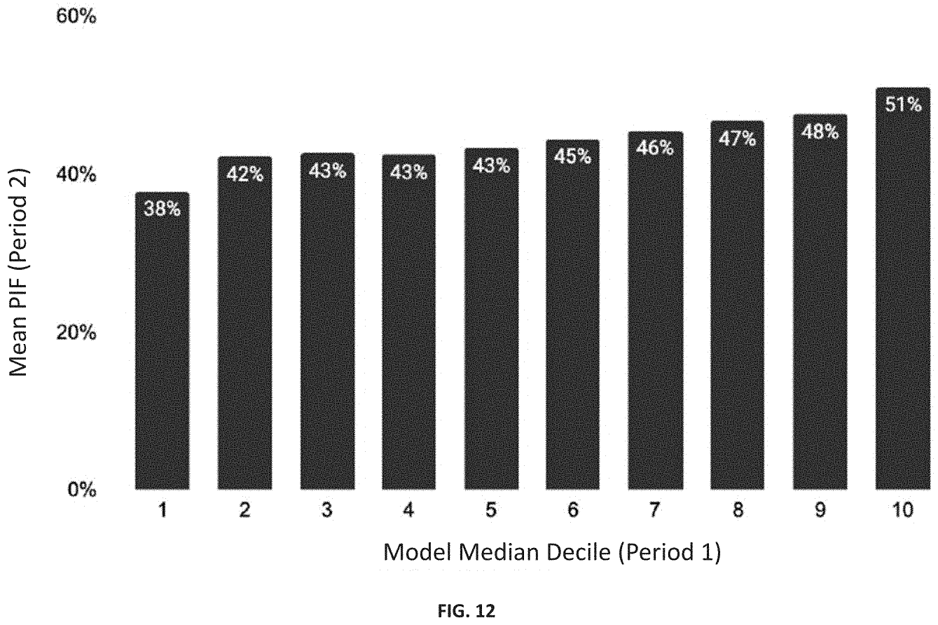

FIG. 12 depicts another example bar graph representing a performance metric of each decile of a population of entities in state-industry combination sub-populations. Each decile has been determined as described above according to the inferred index distribution 161 and an inferred median. Each decile has been constructed according to a Period 1 activity-related quantity indices, with each bar for each decile representing a Period 2 performance metric for the associated sub-populations of each decile. As shown, the decile based on inferred statistics and quality scores is correlated with the performance metric of the sub-populations.

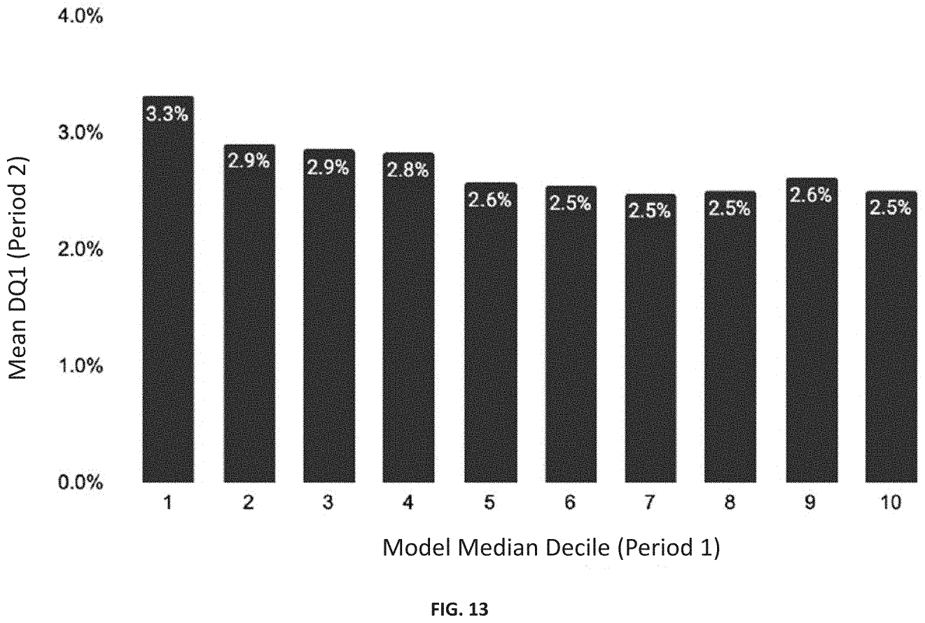

FIG. 13 depicts another example bar graph representing a risk metric of each decile of a population of entities in state-industry combination sub-populations. Each decile has been determined as described above according to the inferred index distribution 161 and an inferred median. Each decile has been constructed according to a Period 1 activity-related quantity indices, with each bar for each decile representing a Period 2 risk metric for the associated sub-populations of each decile. As shown, the decile based on inferred statistics and quality scores is correlated with the risk metric of the sub-populations.

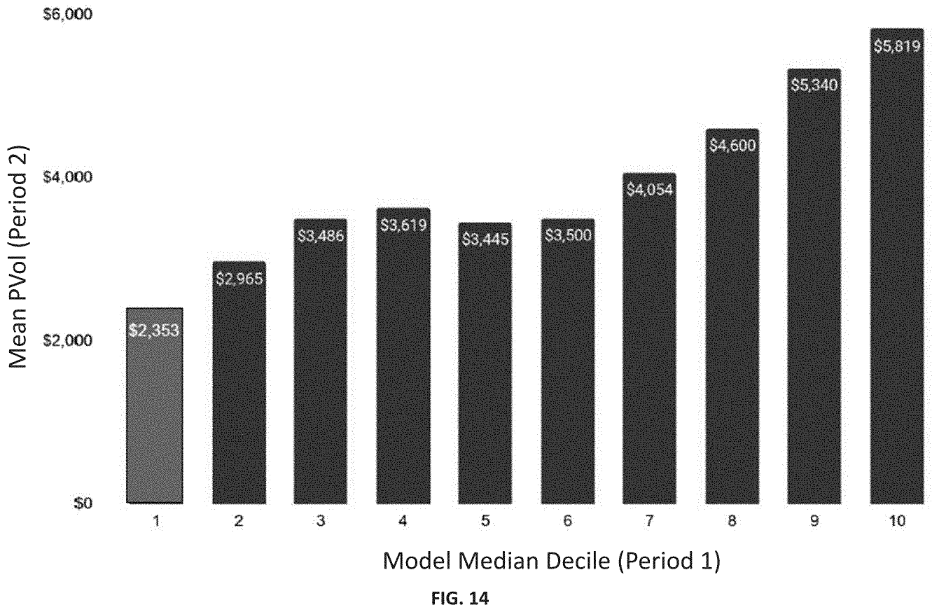

FIG. 14 depicts another example bar graph representing a mean aggregate activity quantity of each decile of a population of entities in state-industry combination sub-populations. Each decile has been determined as described above according to the inferred index distribution 161 and an inferred median. Each decile has been constructed according to a Period 1 activity-related quantity indices, with each bar for each decile representing a Period 2 mean aggregate activity quantity for the associated sub-populations of each decile. As shown, the decile based on inferred statistics and quality scores is correlated with the mean aggregate activity quantity performance of the sub-populations.

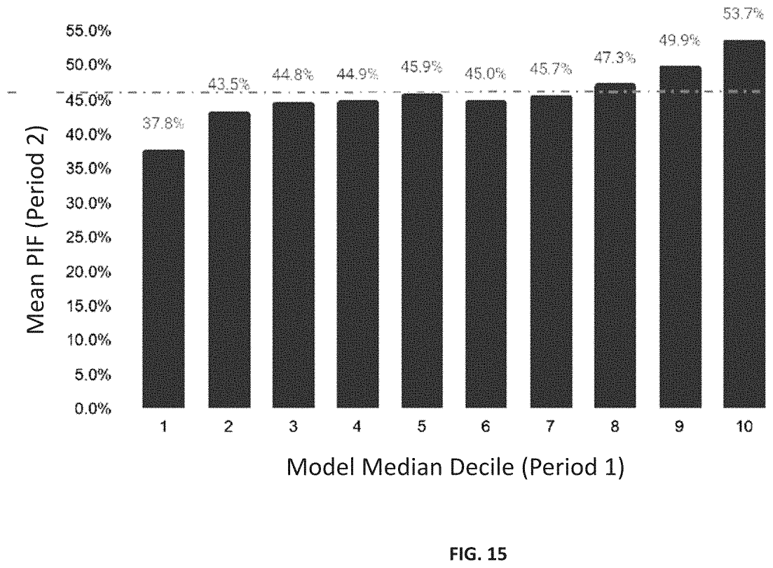

FIG. 15 depicts an example bar graph representing a mean performance metric of each decile of a population of entities in state-industry combination sub-populations. Each decile has been determined as described above according to the inferred index distribution 161. Each decile has been constructed according to a Period 1 activity-related quantity indices, with each bar for each decile representing a Period 2 mean performance metric for the associated sub-populations of each decile. As shown, the decile is correlated with the mean performance metric of the sub-populations.

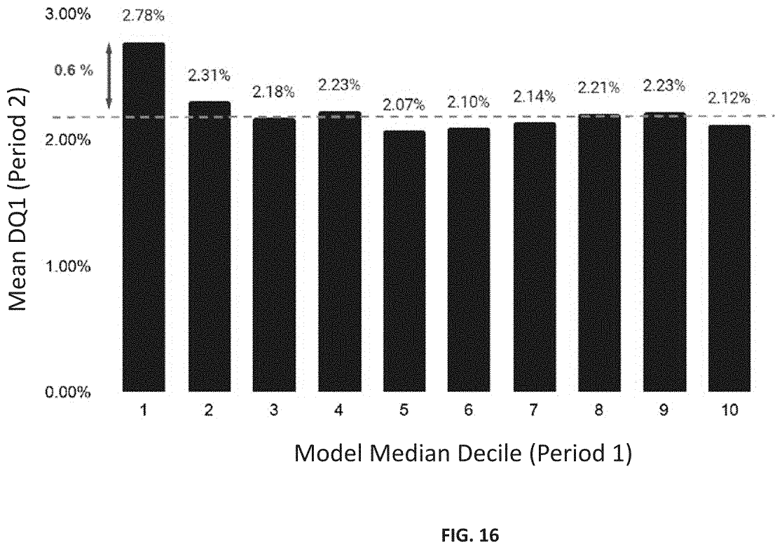

FIG. 16 depicts another example bar graph representing a mean risk metric of each decile of a population of entities in state-industry combination sub-populations. Each decile has been determined as described above according to the inferred index distribution 161 and an inferred median. Each decile has been constructed according to a Period 1 activity-related quantity indices, with each bar for each decile representing a Period 2 mean risk metric for the associated sub-populations of each decile. As shown, the decile based on inferred statistics and quality scores is correlated with the mean risk metric of the sub-populations.

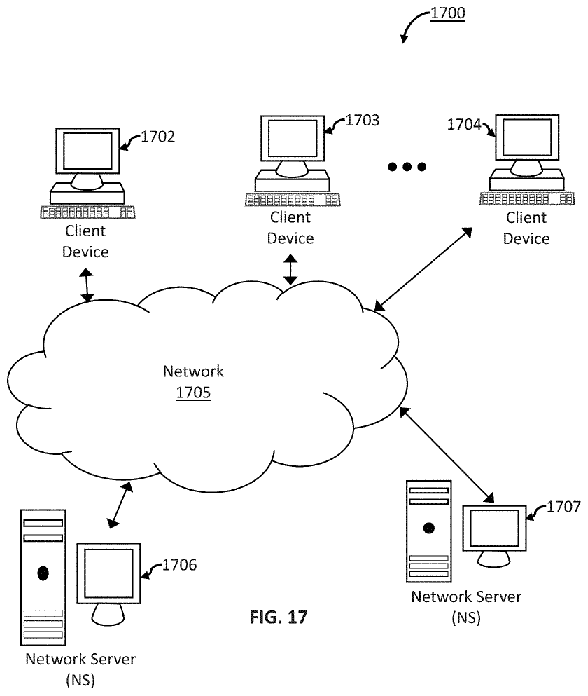

FIG. 17 depicts a block diagram of an exemplary computer-based system and platform 1700 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 1700 may be configured to manage a large number of members and concurrent transactions, as detailed herein. In some embodiments, the exemplary computer-based system and platform 1700 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 17, member device 1702, member device 1703 through member device 1704 (e.g., clients) of the exemplary computer-based system and platform 1700 may include virtually any computing device capable of receiving and sending a message over a network (e.g., cloud network), such as network 1705, to and from another computing device, such as servers 1706 and 1707, each other, and the like. In some embodiments, the member device 1702 through member device 1704 may be personal computers, multiprocessor systems, microprocessor-based or programmable consumer electronics, network PCs, and the like. In some embodiments, one or more member devices within member device 1702 through member device 1704 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member device 1702 through member device 1704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 1702-1704 may include may run one or more applications, such as Internet browsers, mobile applications, voice calls, video games, videoconferencing, and email, among others. In some embodiments, one or more member devices within member device 1702 through member device 1704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 1702-1704 may be specifically programmed by either Java, .Net, QT, C, C++ and/or other suitable programming language. In some embodiments, one or more member devices within member device 1702 through member device 1704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 1705 may provide network access, data transport and/or other services to any computing device coupled to it. In some embodiments, the exemplary network 1705 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 1705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 1705 may include and implement, as an alternative or in conjunction with one or more of the above, a WiMAX architecture defined by the WiMAX forum. In some embodiments and, optionally, in combination of any embodiment described above or below, the exemplary network 1705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 1705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 1705 may also include mass storage, such as network attached storage (NAS), a storage area network (SAN), a content delivery network (CDN) or other forms of computer or machine readable media.

In some embodiments, the exemplary server 1706 or the exemplary server 1707 may be a web server (or a series of servers) running a network operating system, examples of which may include but are not limited to Microsoft Windows Server, Novell NetWare, or Linux. In some embodiments, the exemplary server 1706 or the exemplary server 1707 may be used for and/or provide cloud and/or network computing. Although not shown in FIG. 17, in some embodiments, the exemplary server 1706 or the exemplary server 1707 may have connections to external systems like email, SMS messaging, text messaging, ad content providers, etc. Any of the features of the exemplary server 1706 may be also implemented in the exemplary server 1707 and vice versa.

In some embodiments, one or more of the exemplary servers 1706 and 1707 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 1701-1704.

In some embodiments and, optionally, in combination of any embodiment described above or below, for example, one or more exemplary computing member devices 1702-1704, the exemplary server 1706, and/or the exemplary server 1707 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

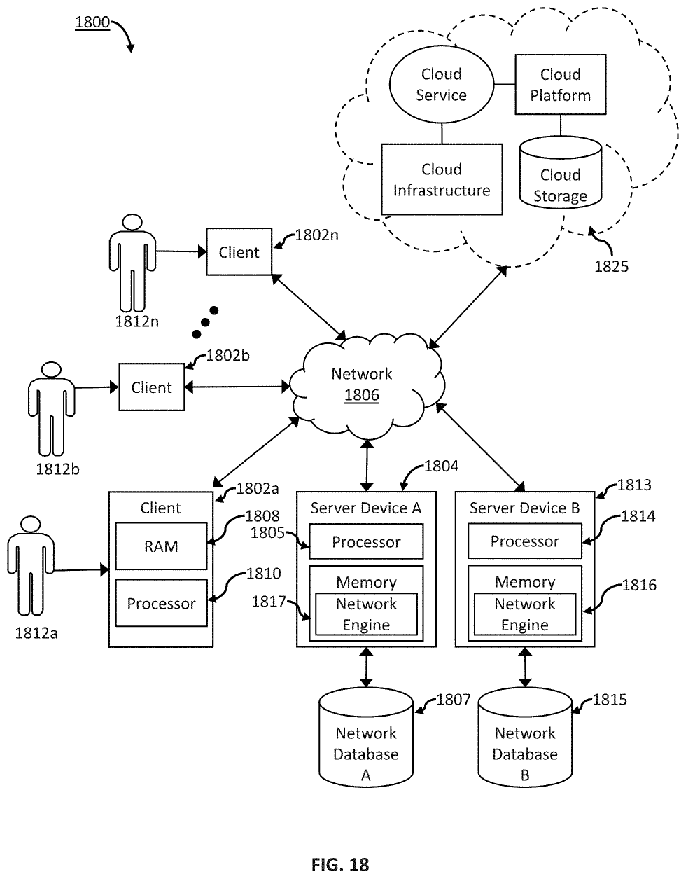

FIG. 18 depicts a block diagram of another exemplary computer-based system and platform 1800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 1802a, member computing device 1802b through member computing device 1802n shown each at least includes a computer-readable medium, such as a random-access memory (RAM) 1808 coupled to a processor 1810 or FLASH memory. In some embodiments, the processor 1810 may execute computer-executable program instructions stored in memory 1808. In some embodiments, the processor 1810 may include a microprocessor, an ASIC, and/or a state machine. In some embodiments, the processor 1810 may include, or may be in communication with, media, for example computer-readable media, which stores instructions that, when executed by the processor 1810, may cause the processor 1810 to perform one or more steps described herein. In some embodiments, examples of computer-readable media may include, but are not limited to, an electronic, optical, magnetic, or other storage or transmission device capable of providing a processor, such as the processor 1810 of member computing device 1802a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 1802a through 1802n may also comprise a number of external or internal devices such as a mouse, a CD-ROM, DVD, a physical or virtual keyboard, a display, or other input or output devices. In some embodiments, examples of member computing devices 1802a through 1802n (e.g., clients) may be any type of processor-based platforms that are connected to a network 1806 such as, without limitation, personal computers, digital assistants, personal digital assistants, smart phones, pagers, digital tablets, laptop computers, Internet appliances, and other processor-based devices. In some embodiments, member computing devices 1802a through 1802n may be specifically programmed with one or more application programs in accordance with one or more principles/methodologies detailed herein. In some embodiments, member computing devices 1802a through 1802n may operate on any operating system capable of supporting a browser or browser-enabled application, such as Microsoft™, Windows™, and/or Linux. In some embodiments, member computing devices 1802a through 1802n shown may include, for example, personal computers executing a browser application program such as Microsoft Corporation's Internet Explorer™, Apple Computer, Inc.'s Safari™, Mozilla Firefox, and/or Opera. In some embodiments, through the member computing devices 1802a through 1802n, user 1812a, user 1812b through user 1812n, may communicate over the exemplary network 1806 with each other and/or with other systems and/or devices coupled to the network 1806. As shown in FIG. 18, exemplary server device 1804 and exemplary server device 1813 may include processor 1805 and processor 1814, respectively, as well as memory 1817 and memory 1816, respectively. In some embodiments, the server devices 1804 and 1813 may be also coupled to the network 1806. In some embodiments, one or more member computing devices 1802a through 1802n may be mobile clients.

In some embodiments, at least one database of exemplary databases 1807 and 1815 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

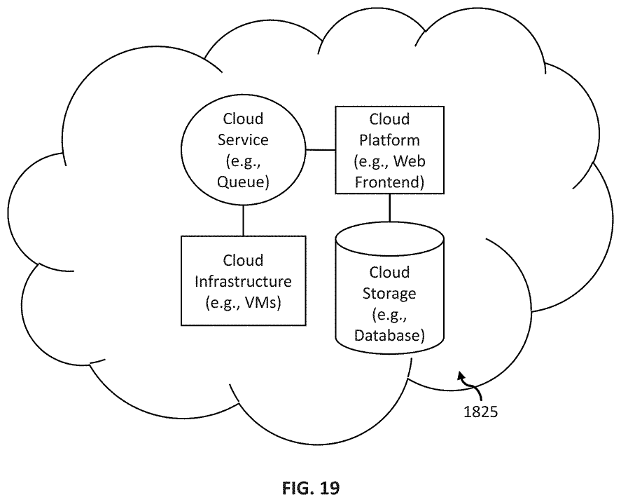

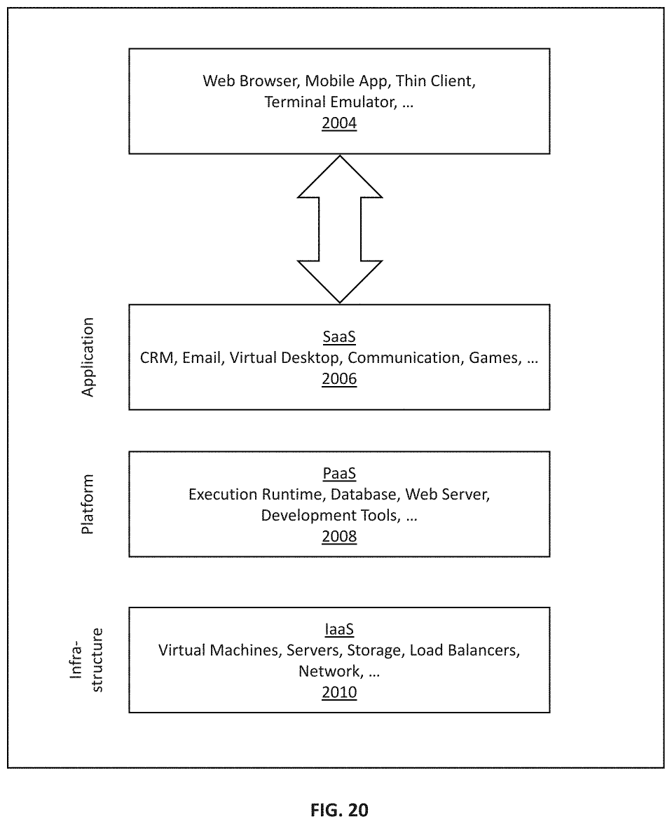

In some embodiments, the exemplary inventive computer-based systems/platforms, the exemplary inventive computer-based devices, and/or the exemplary inventive computer-based components of the present disclosure may be specifically configured to operate in a cloud computing/architecture 1825 such as, but not limiting to: infrastructure a service (IaaS) 2010, platform as a service (PaaS) 1008, and/or software as a service (SaaS) 2006 using a web browser, mobile app, thin client, terminal emulator or other endpoint 2004. FIGS. 19 and 20 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(™), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of ten cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product. For example, exemplary software specifically programmed in accordance with one or more principles of the present disclosure may be downloadable from a network, for example, a website, as a stand-alone product or as an add-in package for installation in an existing software application.

For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH),WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

At least some aspects of the present disclosure will now be described with reference to the following numbered clauses.
1. A method comprising:
   receiving, by at least one processor from an entity database, a numerical data history for a population of entities;
      wherein the numerical data history comprises a series of activity-related quantity indices through time;
      wherein the population of entities comprises a plurality of sub-populations of the entities;
   generating, by the at least one processor, a hierarchical map object representing a hierarchical scheme of sub-populations of the entities within the population of the entities;
   identifying, by the at least one processor, at least one sub-population of the plurality of sub-populations within which a selected sub-population is included based on the hierarchical map object;
   determining, by the at least one processor, a combination of a plurality of normal distributions approximating an index distribution for the at least one sub-population of the entities based on the series of activity-related quantity indices through time;
      wherein at least one normal distribution of the plurality of normal distributions is a respective sub-distribution of the index distribution centered around a respective mean quantity value of a respective sub-population;
   eliminating, by the at least one processor, simulations by using a Bayesian model to approximate an inferred index distribution for a particular sub-population within the population based on the combination of the plurality of normal distributions;
   determining, by the at least one processor, at least one inferred statistical value based on the inferred index distribution; and
filtering, by the at least one processor, the population of entities within the entity database based on the at least one inferred statistical value and a predetermined statistical value threshold.2. A system comprising:
   at least one processor configured to execute software instructions causing the at least one processor to perform steps to:
      receive, from an entity database, a numerical data history for a population of entities;
         wherein the numerical data history comprises a series of activity-related quantity indices through time;
         wherein the population of entities comprises a plurality of sub-populations of the entities;
      generate a hierarchical map object representing a hierarchical scheme of sub-populations of the entities within the population of the entities;
      identify at least one sub-population of the plurality of sub-populations within which a selected sub-population is included based on the hierarchical map object;
      determine a combination of a plurality of normal distributions approximating an index distribution for the at least one sub-population of the entities based on the series of activity-related quantity indices through time;
         wherein at least one normal distribution of the plurality of normal distributions is a respective sub-distribution of the index distribution centered around a respective mean quantity value of a respective sub-population;
      eliminate simulations by using a Bayesian model to approximate an inferred index distribution for a particular sub-population within the population based on the combination of the plurality of normal distributions;
      determine at least one inferred statistical value based on the inferred index distribution; and
      filter the population of entities within the entity database based on the at least one inferred statistical value and a predetermined statistical value threshold.
3. The systems and methods of any of clauses 1 and/or 2, further comprising: 1

determining, by the at least one processor, a quality score associated with the particular sub-population based on the inferred statistical value relative to at least one other inferred statistical value; and
causing to display, by the at least one processor, a quality score user interface on at least one computing device associated with at least one user;
   wherein the quality score user interface comprising one or more user selectable entity records associated with the particular sub-population;
   wherein user selection of one or more user selectable entity records produces an interface component displaying:
      i) the quality score of the particular sub-population associated with the one or more user selectable entity records, and
      ii) a label identifying the particular sub-population associated with the one or more user selectable entity records.
4. The systems and methods of clause 3, further comprising generating, by the at least one processor, a recommendation to market financial services to entities of the particular sub-population wherein the quality score exceeds the predetermined statistical value threshold.
5. The systems and methods of any of clauses 1 and/or 2, wherein the plurality of normal distributions comprises five normal distributions.
6. The systems and methods of any of clauses 1 and/or 2, further comprising:
   generating, by the at least one processor, a first normal distribution around a first fixed position in the series of activity-related quantity indices; and
   generating, by the at least one processor, at least four additional normal distributions according to expectation-maximization of a mean value of each additional normal distribution of the at least four additional normal distributions.
7. The systems and methods of any of clauses 1 and/or 2, wherein the Bayesian model comprises a variational inference mean field approximation.
8. The systems and methods of any of clauses 1 and/or 2, wherein the series of activity-related quantity indices through time comprises a total consumer spend quantity at each merchant in the population for each predetermined time period.
9. The systems and methods of clause 8, wherein each predetermined time period comprises a month.
10. The systems and methods of clause 8, wherein the inferred mean quantity value comprises an inferred mean consumer spend quantity at each merchant in the particular sub-population in a predetermined time period.
11. The systems and methods of clause 8, wherein the quality score comprises a mean consumer spend quantity categorization in one of ten groupings ranked by consumer spend quantities.
12. The systems and methods of clause 11, further comprising generating, by the at least one processor, a purchase volume ranking of entities in the particular sub-population based on the mean consumer spend quantity categorization.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added, and/or any desired steps may be eliminated).

1. A method comprising:
receiving, by at least one processor from an entity database, a numerical data history for a population of entities;
wherein the numerical data history comprises a series of activity-related quantity indices through time;
wherein the population of entities comprises a plurality of sub-populations of the entities;
generating, by the at least one processor, a hierarchical map object representing a hierarchical scheme of sub-populations of the entities within the population of the entities;
identifying, by the at least one processor, at least one sub-population of the plurality of sub-populations within which a selected sub-population is included based on the hierarchical map object;
determining, by the at least one processor, a combination of a plurality of normal distributions approximating an index distribution for the at least one sub-population of the entities based on the series of activity-related quantity indices through time;
wherein at least one normal distribution of the plurality of normal distributions is a respective sub-distribution of the index distribution centered around a respective mean quantity value of a respective sub-population;
eliminating, by the at least one processor, simulations by using a Bayesian model to approximate an inferred index distribution for a particular sub-population within the population based on the combination of the plurality of normal distributions;
determining, by the at least one processor, at least one inferred statistical value based on the inferred index distribution; and
filtering, by the at least one processor, the population of entities within the entity database based on the at least one inferred statistical value and a predetermined statistical value threshold.

2. The method of claim 1, further comprising:
determining, by the at least one processor, a quality score associated with the particular sub-population based on the inferred statistical value relative to at least one other inferred statistical value; and
causing to display, by the at least one processor, a quality score user interface on at least one computing device associated with at least one user;
wherein the quality score user interface comprising one or more user selectable entity records associated with the particular sub-population;
wherein user selection of one or more user selectable entity records produces an interface component displaying:
i) the quality score of the particular sub-population associated with the one or more user selectable entity records, and
ii) a label identifying the particular sub-population associated with the one or more user selectable entity records.

3. The method of claim 2, further comprising generating, by the at least one processor, a recommendation to market financial services to entities of the particular sub-population wherein the quality score exceeds the predetermined statistical value threshold.

4. The method of claim 1, wherein the plurality of normal distributions comprises five normal distributions.

5. The method of claim 1, further comprising:
generating, by the at least one processor, a first normal distribution around a first fixed position in the series of activity-related quantity indices; and
generating, by the at least one processor, at least four additional normal distributions according to expectation-maximization of a mean value of each additional normal distribution of the at least four additional normal distributions.

6. The method of claim 1, wherein the Bayesian model comprises a variational inference mean field approximation.

7. The method of claim 1, wherein the series of activity-related quantity indices through time comprises a total consumer spend quantity at each merchant in the population for each predetermined time period.

8. The method of claim 7, wherein each predetermined time period comprises a month.

9. The method of claim 7, wherein the inferred mean quantity value comprises an inferred mean consumer spend quantity at each merchant in the particular sub-population in a predetermined time period.

10. The method of claim 7, wherein the quality score comprises a mean consumer spend quantity categorization in one of ten groupings ranked by consumer spend quantities.

11. The method of claim 10, further comprising generating, by the at least one processor, a purchase volume ranking of entities in the particular sub-population based on the mean consumer spend quantity categorization.

12. A system comprising:
at least one processor configured to execute software instructions causing the at least one processor to perform steps to:
receive, from an entity database, a numerical data history for a population of entities;
wherein the numerical data history comprises a series of activity-related quantity indices through time;
wherein the population of entities comprises a plurality of sub-populations of the entities;
generate a hierarchical map object representing a hierarchical scheme of sub-populations of the entities within the population of the entities;
identify at least one sub-population of the plurality of sub-populations within which a selected sub-population is included based on the hierarchical map object;
determine a combination of a plurality of normal distributions approximating an index distribution for the at least one sub-population of the entities based on the series of activity-related quantity indices through time;
wherein at least one normal distribution of the plurality of normal distributions is a respective sub-distribution of the index distribution centered around a respective mean quantity value of a respective sub-population;
eliminate simulations by using a Bayesian model to approximate an inferred index distribution for a particular sub-population within the population based on the combination of the plurality of normal distributions;
determine at least one inferred statistical value based on the inferred index distribution; and
filter the population of entities within the entity database based on the at least one inferred statistical value and a predetermined statistical value threshold.

13. The system of claim 12, wherein the plurality of normal distributions comprises five normal distributions.

14. The system of claim 12, wherein the software instructions further cause that at least one processor to perform steps to:
generate a first normal distribution around a first fixed position in the series of activity-related quantity indices; and
generate at least four additional normal distributions according to expectation-maximization of a mean value of each additional normal distribution of the at least four additional normal distributions.

15. The system of claim 12, wherein the Bayesian model comprises a variational inference mean field approximation.

16. The system of claim 12, wherein the series of activity-related quantity indices through time comprises a total consumer spend quantity at each merchant in the population for each predetermined time period.

17. The system of claim 16, wherein each predetermined time period comprises a month.

18. The system of claim 16, wherein the inferred mean quantity value comprises an inferred mean consumer spend quantity at each merchant in the particular sub-population in a predetermined time period.

19. The system of claim 16, wherein the quality score comprises a mean consumer spend quantity categorization in one of ten groupings ranked by consumer spend quantities.

20. The system of claim 19, wherein the software instructions further cause that at least one processor to perform steps to generate a purchase volume ranking of entities in the particular sub-population based on the mean consumer spend quantity categorization.
